(19) United States
(12) Patent Application Publication
(10) Pub. No.: US 2007/0044635 A1
(43) Pub. Date: Mar. 1, 2007

(54) Flute attachment

(76) Inventor: Ho-Fan Lee, Yung-Ho City (TW)

Correspondence Address: PILLSBURY WINTHROP SHAW PITTMAN, LLP, P.O. BOX 10500, MCLEAN, VA, 22102, US

(21) Appl. No.: 11/349,197

(22) Filed: Feb. 8, 2006

(30) Foreign Application Priority Data
Aug. 11, 2005 (TW) 094213789

(51) Int. Cl. G10D 7/02

(52) U.S. Cl. 84/384

(57) ABSTRACT

A flute attachment includes a flexible securing member and a resisting member. The securing member is attached to a lower flute surface for resting of a thumb of the flute player, and has a base segment defining a rear pad region and having a front lateral edge in frictional engagement with a front flute surface. The resisting member includes a fulcrum region joined with a rear lateral edge of the base segment, a weight end extending outward from the fulcrum region, and a tab end extending from the fulcrum region and away from the flute axis. The tab end and the rear pad region define a thumb abutting area for application of forces to prevent undesirable rotation of the flute about the flute axis and to prevent undesirable downward displacement and deviation of the flute during playing.

### CROSS-REFERENCE TO RELATED APPLICATION

This application claims priority of Taiwanese Application No. 094213789, filed on Aug. 11, 2005.

### BACKGROUND OF THE INVENTION

1. Field of the Invention

The invention relates to a flute attachment, more particularly to a flute attachment which is adapted for resting of a right thumb of a flute player thereon to guard against undesirable rotation of the flute, as well as to support and balance the flute.

2. Description of the Related Art

FIGS. 1 and 2 show schematically a conventional flute 1, in which, as well as in the rest of the accompanying drawings, the arrow (X) represents a left-to-right direction, the arrow (Z) indicates a top-to-bottom direction, and the arrow (Y) indicates a front-to-rear direction. The flute 1 has a plurality of keys 11 provided on a round tubular wall thereof along an axial direction. In general, a flute player 102 uses all the five fingers of the left hand to operate the keys 11, with a root portion of the left index finger abutting against a lower portion of the tubular wall substantially near the center of gravity of the flute 1 so that the left index finger bears a large part of the weight of the flute 1 that acts downward in a direction indicated by the arrow (A). The right hand of the flute player 102 is placed near a foot joint of the flute 1. Except for the right thumb 100 which is placed below the tubular wall of the flute 1 to support and balance the weight of the flute 1, the rest of the fingers of the right hand are used to operate the keys 11. In addition, since the keys 11, plates, and rods of the flute 1 are provided on upper and rear portions of the tubular wall of the flute 1, the entire flute 1 is liable to rotate about its axis toward the flute player 102, as indicated by the arrow (S) in FIGS. 1 and 2, thereby resulting in the so-called sectional rotation problem.

Referring to FIG. 3, since the flute 1 is held horizontally when being played, if the right hand of the flute player 102 does not apply a proper force to the part of the flute 1 supported thereby during playing, the entire flute 1 will deviate toward the rear right side of the player 102 in a direction indicated by the arrow (H) due to the pressure applied to the mouthpiece 14 of the flute 1 at the chin of the flute player 102 and the force exerted by the left index finger of the player 102, which is referred to as a horizontal rotation problem.

The above-stated problems not only annoy the flute player 102, they will also affect the overall performance of the flute player 102. Therefore, how to make the best use of the right thumb 100 in helping to support and balance the flute 1 is a primary concern of the present invention.

Referring to FIG. 4, in order to solve the problem associated with placement of the right thumb 100, as well as the problem associated with sectional rotation of the flute 1, Otto Mönnig, a flute maker in Leipzig, developed a thumb support 2 which is provided on the flute 1 at a position where the right thumb 100 should rest for supporting the flute 1. Although the aforesaid thumb support 2 can provide a force arm extending laterally of the tubular wall of the flute 1 to allow the right thumb 100 to apply a rotational force in a direction opposite to the direction of rotation of the flute 1 denoted by the arrow (S) in FIG. 2 to thereby solve the problem of sectional rotation, it does not permit generation of a horizontal force to resolve the problem associated with horizontal rotation of the flute 1. Moreover, the right thumb 100 cannot help support the weight of the flute 1 effectively.

Later, a musical instrument accessory maker, Bo-Pep, launched a thumb guide product, denoted at 21 in FIG. 5. However, the thumb guide 21 serves only to increase the distance between the right index finger 101 and the right thumb 100 so as to reduce the tenseness of the muscle in the first web space of the right hand and to increase the frictional force between the right thumb 100 and the flute 1. The thumb guide 21 is still unable to provide the right thumb 100 with a relatively large area nor an arm of force for application of a force sufficient to counteract the aforesaid horizontal rotation and sectional rotation.

Referring back to FIG. 1, regardless of whether or not the flute 1 is equipped with a support accessory for resting of the right thumb 100 thereagainst, the flute player 102 in general will use his/her little finger in conjunction with the right thumb 100 to hold the flute 1 in position, whether intentionally or unintentionally. However, as the little finger needs to operate one of the keys 11 while cooperating with the right thumb 100 to hold the flute 1, the little finger will be somewhat crippled in operating the key 11. Besides, during shifting of the little finger over the keys 11, shaking of the flute 1 may result due to non-uniform force distribution, thereby affecting the performance of the flute player 102.

### SUMMARY OF THE INVENTION

Therefore, the object of the present invention is to provide a flute attachment that can solve the aforesaid horizontal rotation and sectional rotation problems commonly encountered in the prior art besides supporting partial weight of a flute.

Accordingly, a flute attachment of the present invention is adapted for use on a flute having a round tubular flute body extending along a flute axis and having upper and lower surfaces opposite to each other in a first direction transverse to the flute axis, and front and rear surfaces opposite to each other in a second direction transverse to the first direction. The flute body includes a head joint having a mouthpiece, a foot joint, a body joint between the head and foot joints, and a plurality of rods and keys which are disposed such that in a play position, as a result of weights of the rods and keys, an urging force is generated to rotate the upper surface about the flute axis towards a flute player. The flute attachment includes a securing member and a resisting member. The securing member is formed from a flexible material, and is adapted to be attached fittingly to the lower surface of the flute body for a thumb of the flute player to normally rest thereagainst to thereby balance and support the flute. The securing member includes a base segment which is disposed beneath the lower surface, and which extends angularly about the flute axis to form front and rear pad regions that terminate respectively at front and rear lateral edges which are opposite to each other in the second direction. The front lateral edge is configured to be in frictional engagement with the front surface. The resisting member includes a fulcrum region joined with the rear lateral edge, a weight end extending from the fulcrum region towards the rear surface, and a tab end which extends from the fulcrum region and away from the flute axis, and which, in cooperation with the rear pad region, defines a thumb abutting area such that, as a result of resting of the thumb of the flute player against the rear pad region, a primary thumb force, which is directed towards the flute axis, is generated to partly counteract a tendency of the flute to displace downwardly due to application of forces on the keys by the other fingers of the flute player and partial weight of a flute and to partly prevent undesirable deviation of the foot joint toward the flute player due to application of pressure to the mouthpiece, while a secondary thumb force acts on the tab end to bring the weight end to abut against the rear surface so as to guard against rotation of the body joint about the flute axis toward the flute player.

### BRIEF DESCRIPTION OF THE DRAWINGS

Other features and advantages of the present invention will become apparent in the following detailed description of the preferred embodiment with reference to the accompanying drawings, of which:

FIG. 1 is a rear view showing how a flute is held in a play position and sectional rotation of the flute;

FIG. 2 is a schematic side view further illustrating the sectional rotation of the flute;

FIG. 3 is a top view showing how the flute is held in the play position and horizontal rotation of the flute;

FIG. 4 shows a thumb support of the prior art;

FIG. 5 shows a thumb guide of the prior art;

FIG. 6 is a top view illustrating the position of a preferred embodiment of a flute attachment according to the present invention attached to a flute;

FIG. 7 is a perspective view of the preferred embodiment when attached to the flute;

FIG. 8 is a schematic side view of the preferred embodiment, illustrating application of force by a right thumb of a flute player to counteract horizontal rotation of the flute in a play position; and

FIG. 9 is a schematic top view of the preferred embodiment, illustrating how a force is applied to counteract sectional rotation of the flute in the play position.

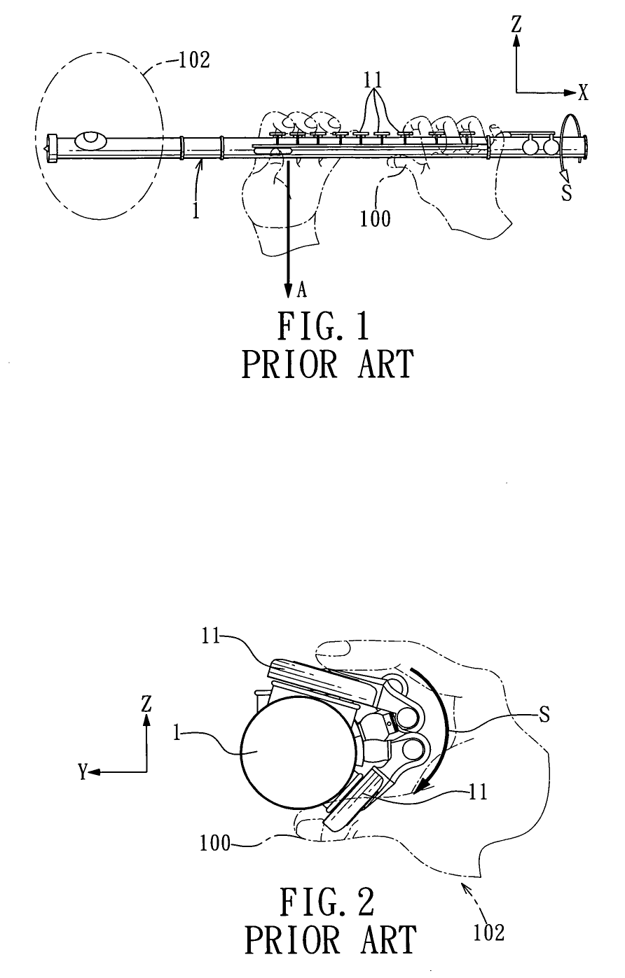

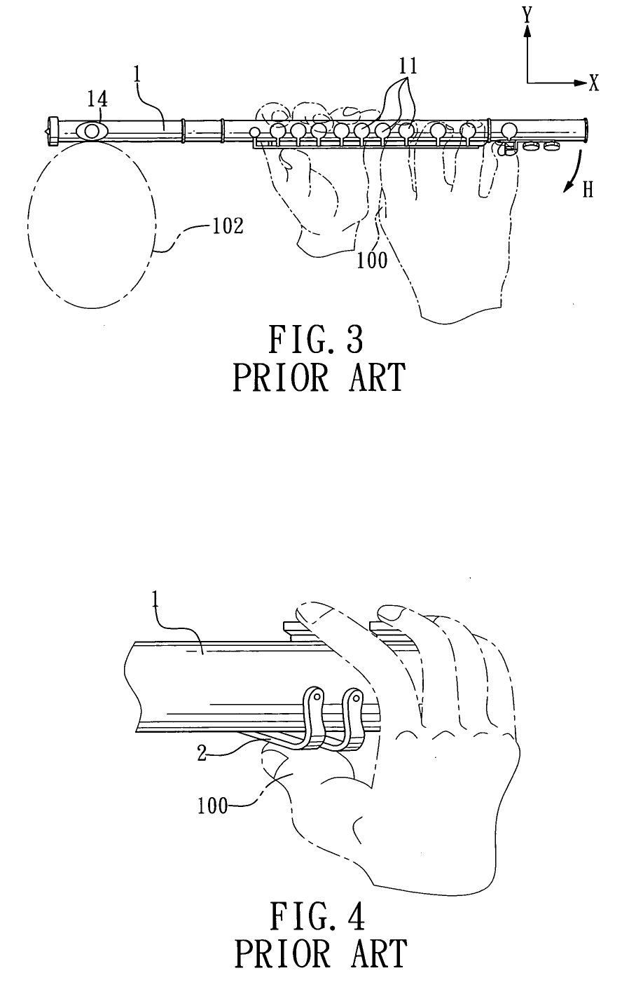

### DETAILED DESCRIPTION OF THE PREFERRED EMBODIMENT

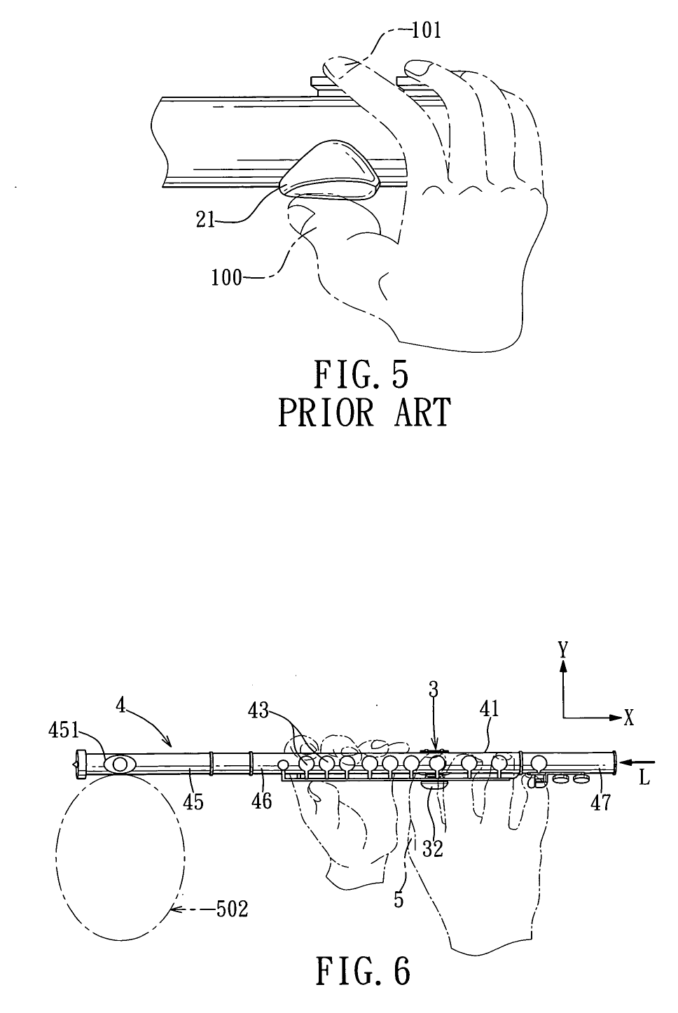

Referring to FIG. 6, the preferred embodiment of a flute attachment 3 according to the present invention is shown to be attached to a flute 4 having a round tubular flute body 41 extending along a flute axis (L) and having upper and lower surfaces opposite to each other in a first direction transverse to the flute axis (L), and front and rear surfaces opposite to each other in a second direction transverse to the first direction. The flute body 41 includes a head joint 45 having a mouthpiece 451, a foot joint 47, a body joint 46 between the head and foot joints 45, 47, and a plurality of rods and keys 43 which are disposed such that in a play position, as a result of weights of the rods and keys 43, an urging force is generated to rotate the upper surface about the flute axis (L) toward a flute player 502 (see FIG. 8), which results in the so-called sectional rotation problem.

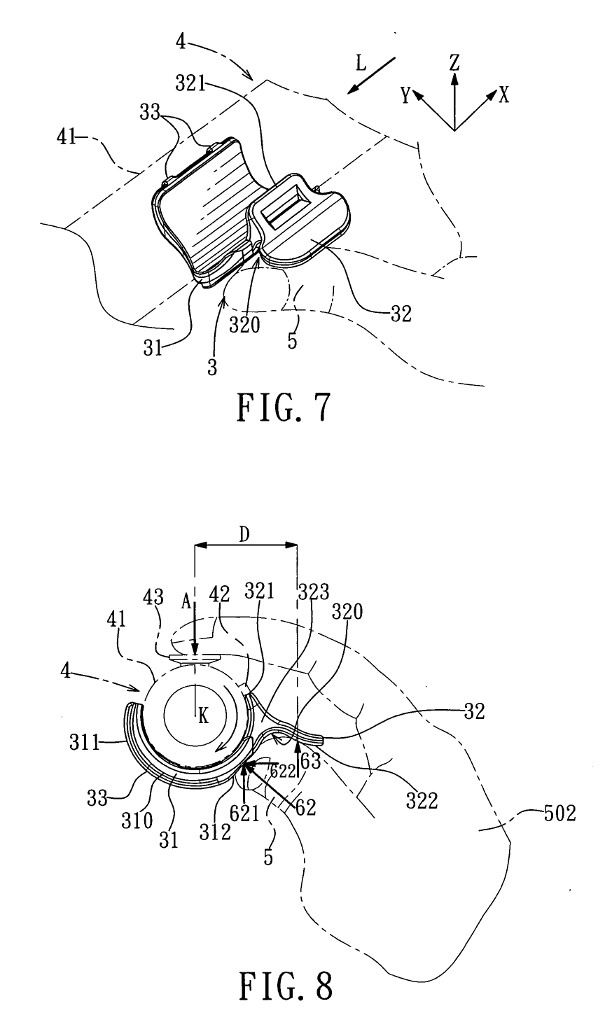

Referring further to FIGS. 7 and 8, the flute attachment 3 includes a securing member 31 and a resisting member 32. The securing member 31 is formed from a flexible material, and is adapted to be attached fittingly to the lower surface of the flute body 41 for a thumb 5 of a flute player 502 to normally rest thereagainst to thereby balance and support the flute 4. Preferably, the area of contact between the securing member 31 and the flute body 41 is minimized so as not to affect the vibration of the flute 4 during playing. Besides, it is noted that the position of the flute attachment 3 on the flute 4 is adjustable to suit individual flute players, and that the flute attachment 3 can be adapted for use on other musical instruments of the flute family that are generally held in a horizontal position during playing.

The securing member 31 includes a base segment 310 which is disposed beneath the lower surface of the flute body 41, and which extends angularly about the flute axis (L) to form front and rear pad regions 311, 312 that terminate respectively at front and rear lateral edges which are opposite to each other in the second direction. The front lateral edge is configured to be in frictional engagement with the front surface of the flute body 41. In this embodiment, the securing member 31 is configured to be substantially C-shaped, and is adapted to clamp the flute 4. However, in actual practice, the securing member 31 can be configured to have other suitable shapes, and can be attached to the flute 4 by bonding or threaded fasteners.

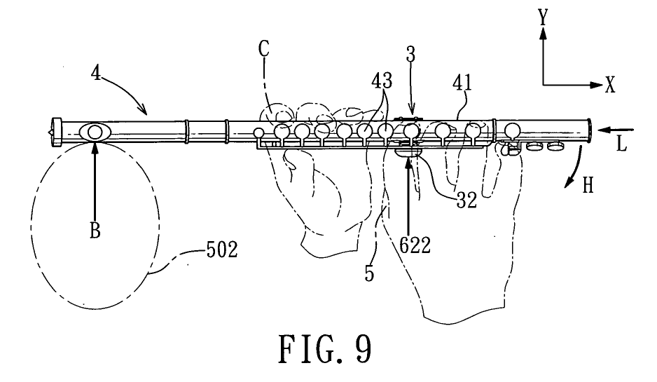

The resisting member 32 includes a fulcrum region 323 joined with the rear lateral edge, a weight end 321 extending from the fulcrum region 323 towards the rear surface of the flute body 41, and a tab end 322 which extends from the fulcrum region 323 and away from the flute axis (L) and which, in cooperation with the rear pad region 312, defines a thumb abutting area 320. When the flute player 502 rests his/her thumb 5 against the rear pad region 312, a primary thumb force 62 directed towards the flute axis (L) is generated. The primary thumb force 62 includes a vertical force component 621 that counteracts a tendency of the flute 4 to displace downwardly in the direction indicated by arrow (A) due to application of forces on the keys 43 by the other fingers of the flute player 502, and that can support a part of the weight of the flute 4, and a horizontal force component 622 that can prevent undesirable deviation of the foot joint 47 toward the right side of the flute player 502 in a direction indicated by the arrow (H) (see FIG. 9) due to application of pressure to the mouthpiece 451 in a direction denoted by (B) in FIG. 9, and due to application of pressure to the body joint 46 by the index finger (denoted by (C) in FIG. 9) of the flute player 502. Thus, the problem of horizontal rotation associated with prior art flutes can be overcome.

On the other hand, the resting of the thumb 5 against the rear pad region 312 also results in the simultaneous generation of a secondary thumb force 63 to act on the tab end 322 to bring the weight end 321 to abut against the rear surface of the flute 4, which, combined with an arm of force (D) from the point of the secondary thumb force 63 to a center (K) of the flute body 41, guards against rotation of the body joint 46 about the flute axis (L) toward the flute player 502 due to concentration of mechanical parts of the flute 4 on the side of the flute player 502 during playing. Thus, the problem of sectional rotation associated with prior art flutes can also be alleviated.

In this embodiment, the tab end 322 forms an obtuse angle with the rear pad region 312. The size of the obtuse angle can be varied to accommodate different flute players.

To prevent undesired rotation of the flute attachment 3 relative to the flute 4 due to the thumb forces, the weight end 321 can be adapted to abut against a rib 42 provided on the flute body 41 or a strip interconnecting the keys 43.

Furthermore, the front pad region 311 may be provided with reinforcing ribs 33 that extend angularly from the rear pad region 312 to the front lateral edge.

As illustrated, due to the configuration of the flute attachment 3 of this invention, the flute attachment 3 not only can serve as a thumb rest for positioning of the right thumb of the flute player, it also provides a relatively large area for the flute player to apply a sufficient thumb force to the flute to support and balance the weight of the flute, as well as to prevent undesirable rotation and deviation of the flute toward the flute player.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A flute attachment for a flute having a round tubular flute body extending along a flute axis and having upper and lower surfaces opposite to each other in a first direction transverse to the flute axis, and front and rear surfaces opposite to each other in a second direction transverse to the first direction, the flute body including a head joint having a mouthpiece, a foot joint, a body joint between the head and foot joints, and a plurality of rods and keys which are disposed such that in a play position, as a result of weights of the rods and keys, an urging force is generated to rotate the upper surface about the flute axis towards a flute player, said flute attachment comprising:
a securing member formed from a flexible material and adapted to be attached fittingly to the lower surface of the flute body for a thumb of the flute player to normally rest thereagainst to thereby balance and support the flute, said securing member including a base segment which is disposed beneath the lower surface, and which extends angularly about the flute axis to form front and rear pad regions that terminate respectively at front and rear lateral edges which are opposite to each other in the second direction, said front lateral edge being configured to be in frictional engagement with the front surface; and
a resisting member including a fulcrum region joined with said rear lateral edge, a weight end extending from said fulcrum region towards the rear surface, and a tab end which extends from said fulcrum region and away from the flute axis, and which, in cooperation with said rear pad region, defines a thumb abutting area such that, as a result of resting of the thumb of the flute player against said rear pad region, a primary thumb force, which is directed towards the flute axis, is generated to partly counteract a tendency of the flute to displace downwardly due to application of forces on the keys by the other fingers of the flute player and partial weight of a flute and to partly prevent undesirable deviation of the foot joint toward the flute player due to application of pressure to the mouthpiece, while a secondary thumb force acts on said tab end to bring said weight end to abut against the rear surface so as to guard against rotation of the body joint about the flute axis toward the flute player.

2. The flute attachment as claimed in claim 1, wherein said tab end forms an obtuse angle with said rear pad region.

3. The flute attachment as claimed in claim 2, wherein said front pad region is provided with a reinforcing rib that extends angularly from said rear pad region to said front lateral edge.
